(19) United States
(12) Patent Application Publication
(10) Pub. No.: US 2018/0327698 A1
(43) Pub. Date: Nov. 15, 2018

(54) ALCOHOLIC FOAM

(71) Applicants: Ibex SarI, Jacob-Bellecombette (FR); Durden Concept Sarl, Geneve (CH)

(72) Inventors: Cédric PERRIER, Moutier (CH); Olivier MARMET, Jacob-Bellecombette (FR); Guillaume LASSIS-LAVY, Aix-les-Bains (FR)

(21) Appl. No.: 15/775,742

(22) PCT Filed: Nov. 20, 2015
(86) PCT No.: PCT/IB2015/059005

§ 371 Date: May 11, 2018

(51) Int. Cl. C12G 3/04; A23L 29/231; A23P 30/40

(52) U.S. Cl. CPC C12G 3/04; A23V 2002/00; A23P 30/40; A23L 29/231

(57) ABSTRACT

The present invention concerns an alcoholic foam, a use and a method for preparing said foam, the foam comprising:—An aqueous ethanolic solution;—An aqueous solution constituted essentially of water;—Between about 0.5 g.L.⁻¹ and about 10 g.L.⁻¹of at least a surfactant;—Between about 0.5 g.L.⁻¹ and 10 g.L.⁻¹ of pectin;

### FIELD OF THE INVENTION

The present invention concerns an alcoholic foam, use and method of preparing thereof.

### DESCRIPTION OF RELATED ART

Alcoholic beverages have been presented in a liquid form for ages. Wine and wine growing were landmarks of the Roman Empire that is associated with many decisive breakthroughs in winemaking. In northern Europe, the first evidence of whiskey can be traced back to 15^{th} century thanks to the development of the art of distillation especially in Scotland or in Ireland.

Recently, there is an arising demand for alcoholic beverage in alternative forms, such as gel, emulsion or foam, that are considered as modern forms for consuming alcohol beverage compared to the traditional liquid form.

However, it rapidly appeared that alcohol and in particular ethanol is a disturbing agent in non-liquid beverage. The presence of alcohol in foams or emulsion destabilizes the foam or emulsion so that it is necessary to add additives to the foam or emulsion to balance the disturbing effect of alcohol. The beverage industry developed several alternatives in this respect.

One solution is to add proteins to stabilize the foam. For instance, the document WO 2012/010652 discloses an alcoholic composition that comprises egg white proteins.

An alternative solution is to transform the liquid beverage into an emulsion by adding a fatty material, for instance diary derivatives. The document WO2008/008393 describes an alcoholic emulsion that comprises cream, whole milk or skim milk.

Another solution to obtain a non-liquid form of alcoholic beverage is to prepare a gel. The document WO 2012/123742 describes gel-base shots made by dissolving gelatin in an alcoholic composition comprising a flavor agent, fruit juice and water. Contrary to the liquid or to the foam, a gel is defined as a substantially diluted cross-linked system, which exhibits no flow when in the steady-state.

Adding proteins or fatty material not only influences the form of the emulsion or foam, it also impacts the flavor of the beverage and its texture. The user expects an alcoholic foam to be light, fresh, and punchy. On the contrary, proteins or fatty material provides emulsions or foams that tend to be viscous, dense or pasty. Proteins and fatty material also add unwanted calories to the beverage and tend to make them less healthy.

Therefore, there is a need for an alcoholic foam that contain a minimum amount of additives to preserve the features of a foam, such as the lightness and the freshness.

### BRIEF SUMMARY OF THE INVENTION

One of the aim of the invention is to provide a foam free from the limitations of the known foams.

One of the aim of the invention is to provide a foam as light and/or fresh as possible.

Another aim of the invention is to provide a foam viscous less, in the foam state and/or in a liquid state when the foam is gasless.

Another aim of the invention is to provide a foam with the minimum amount of additive such as surfactants, sugar, fatty material, proteins, or others diary derivatives.

Another aim of the invention is to provide a sustainable foam, meaning a foam that will remain in a foam state long enough so that a user can enjoy the beverage.

According to the invention, these aims are achieved by means of an alcoholic foam comprising:

An aqueous ethanolic solution;
An aqueous solution constituted essentially of water;
Between about 0.5 g.L.⁻¹ and about 10 g.L.⁻¹ of at least a surfactant;
Between about 0.5 g.L.⁻¹ and 10 g.L.⁻¹ of pectin;

The inventors found out that it is possible to prepare an alcoholic foam based on an aqueous ethanolic solution that further comprises a combination of at least a surfactant with pectin. In particular, the presence of pectin allows minimizing the necessary amount of surfactant which allows improving the freshness and the lightness of the foam. The pectin can comprise amidated pectin and/or non amidated pectin. Pectin particularly suitable for a foam according to the present invention comprises E440. In one embodiment, the foam comprises between about 0.8 g.L.⁻¹ and about 5.0 g.L.⁻¹ of pectin, preferably between about 0.8 g.L.⁻¹ and about 1.3 g.L.⁻¹ of pectin.

Ethanol is classically described as a foam disturbing agent. In particular, it has been reported that difficulties can be encountered when it comes to providing foam with either moderate ethanol concentration typically around 10% by volume of ethanol and below, or high ethanol concentration above 25% by volume of ethanol and above. Advantageously, the present invention allows preparing foam with a wide range of alcohol concentrations contrary to the prior art, in particular alcoholic foam comprising from 0.5% by volume of ethanol until 60% by volume of ethanol.

The present invention also allows preparing foam without alcohol, said foam comprising an aqueous solution constituted essentially of water, between about 0.5 g.L.-1 and about 10 g.L.-1 of at least a surfactant, between about 0.5 g.L.-1 and 10 g.L.-1 of pectin. The embodiments describe herein for the alcoholic foam also applies mutatis mutandis to the foam without alcohol.

In one embodiment, the aqueous ethanolic solution comprises between 0.5% by volume of ethanol and 99.5% by volume of ethanol, preferably between about 10% by volume of ethanol and 60% by volume of ethanol, more preferably between about 35% by volume of ethanol and 55% by volume of ethanol.

In one embodiment, the aqueous ethanolic solution comprises between about 10% by volume of ethanol and 25% by volume of ethanol. Typically, the aqueous ethanolic solution can comprise wine, ciders, or any other fruits based alcohol, in particular to obtain alcoholic foam with a moderate ethanol concentration.

In another embodiment, the aqueous ethanolic solution comprises between about 35% by volume of ethanol and 55% by volume of ethanol. For instance, the aqueous ethanolic solution can comprise commercially available alcohol classically used for preparing beverage or cocktails, such as vodka, rum, gin, whisky, absinthe, tequila, neutral spirit or combination thereof, in particular to obtain alcoholic foam with a high ethanol concentration.

In another embodiment, the aqueous ethanolic solution comprises between about 85% by volume of ethanol and 99.5% by volume of ethanol. For example, the aqueous ethanolic solution can comprise neutral spirit.

In an embodiment, the foam comprises between about 5% by volume and 95% by volume of aqueous ethanolic solution, preferably between about 50% by volume and 90% by volume of aqueous ethanolic solution, more preferably between about 80% by volume and 85% by volume of aqueous ethanolic solution.

In an embodiment, the alcoholic foam comprises between about 1.0 g.L.⁻¹ and about 5.0 g.L.⁻¹ of at least a surfactant, preferably between about 1.0 g.L.⁻¹ and about 1.5 g.L.⁻¹ of at least a surfactant.

According to an embodiment, the surfactant is chosen amongst surfactants with a HLB (hydrophilic lipophilic balance) inferior to 16, preferably inferior to 12, more preferably inferior to 9. The foam according to the present invention can be prepared with a wide range of surfactants.

In many foams of the prior art, it is advised to used surfactants with a HLB superior to 12, in particular superior to 9, to obtain a light and sustainable alcoholic foam. Therefore, according to the prior art, an important range of the existing surfactants are not suitable for preparing an alcoholic foam. Surprisingly, the inventors discover that in a foam according to the present invention, it is possible to use surfactants with a

HLB inferior to 12, or a mix of surfactants with an overall HLB inferior to 12, in particular with a HLB inferior to 9, or a mix of surfactants with an overall HLB inferior to 9 to prepare a light, less viscous and fresh foam.

According to an embodiment, the surfactants are chosen amongst monoglycerides of fatty acids, diglycerides of fatty acids, citric acid esters of monoglycerides of fatty acids, citric acid esters of diglycerides of fatty acids or combination thereof. Surfactants particularly suitable for a foam according to the present invention comprises E471, E472 c alone or in combination.

In an embodiment, the foam comprises between about 0.1 g.L.⁻¹ and about 1.0 g.L.⁻¹ of salts, preferably between about 0.1 g.L.⁻¹ and about 0.3 g.L.⁻¹ of salts. The salts can be chosen from sea salts or other food salts. The salts can be constituted essentially by NaCl, with traces amounts of ions, such as iodine, fluoride.

The presence of salts in the foam allows enhancing the structure of the foam. In particular, the salts enhance the bodying of the pectin in the foam.

The salts also boost the structuring effect of the pectin in the foam. It is important to note that a minimum amount of salts such as between about 0.1 g.L.⁻¹ and about 0.3 g.L.⁻¹ is sufficient to improve the structure of the foam.

According to an embodiment, the foam comprises between about 0.1 g.L.⁻¹ and 1.0 g.L.⁻¹ of carbohydrate, preferably between about 0.5 g.L.⁻¹ and about 0.7 g.L.⁻¹ of carbohydrate. For instance, carbohydrates can comprises sucrose such as beetroot or cane sucrose.

The presence of the carbohydrate helps homogenizing the solution during the preparation of the foam. In particular, the carbohydrate minimize the formation of clumps during the preparation of the foam, in particular during the preparation of the initial solution and/or the stock solution. It is important to note that a minimum amount of carbohydrate such as 0.5 g.L.⁻¹ and about 0.7 g.L.⁻¹ is sufficient to help the preparation of the foam, without masking the flavor or providing a foam with a viscous texture .

In one embodiment, the foam comprises a propellant gas, typically carbon dioxide CO₂ or nitrous oxide N₂O, or mixture thereof.

According to an embodiment, the foam according to the present invention comprises or consists in:

82.5% by volume of aqueous ethanolic solution, said aqueous ethanolic solution comprising 40% by volume of ethanol;
17.5% by volume of an aqueous solution constituted essentially of water so that the volume of aqueous solution ;
Between 1.1 g.L.⁻¹ and 1.6 g.L.⁻¹ of at least a surfactant,
Between about 0.9 g.L.⁻¹ and 1.3 g.L.⁻¹ of pectin;
0.2 g.L.⁻¹ of salts;
0.6 g.L.⁻¹ of carbohydrate.

The present invention also relates to a method for preparing an alcoholic foam according to the present invention, the method comprising the steps of:

i) Preparing an initial solution by mixing the surfactant into at least 10% by volume of the total volume of the aqueous solution bring to the boil, the initial solution being mixed at a temperature between about 80° C. and 100° C. until said initial solution is homogenous;
ii) Preparing a stock solution by adding the pectin to the initial solution, the stock solution being mixed at a temperature between about 80° C. and 100° C. until said stock solution is homogenous;
iii) Preparing a working solution by progressively adding at least 10% by volume of the aqueous ethanolic solution into the stock solution, said stock solution being maintained at a temperature between about 65° C. and about 75° C.

The inventors found out that when the surfactant, the pectin and optionally the carbohydrate and the salts were added all together in the aqueous ethanolic solution combined with the aqueous solution, the resulting mixture was difficult to homogenize. Additionally, the foam was viscous and without the freshness expected by the user when it comes to foam. Once the foam has collapsed, the liquid was viscous as well which provides an unpleasant visual effect in a glass for instance.

On the contrary, in the method according the present invention, homogenizing the initial solution before adding the pectin (and optionally the carbohydrate) allows improving the features of the foam, such as freshness or lightness. Similarly, homogenizing the stock solution before adding the remainder of aqueous ethanolic solution and the remainder of aqueous solution further improve the features of the foam.

Pectin is known to be poorly soluble or nearly insoluble in an alcoholic solution. The inventor found out that a solution to enhance the solubility of pectin is to dissolve pectin in a mixture of aqueous solutions and surfactants in a first step. In a second step, the alcoholic solution can be progressively added to the previously prepared aqueous solution of surfactants and pectin. This two steps procedure allow enhancing the solubility of pectin in alcoholic solution.

The inventors further found out that when the ethanolic aqueous solution and the remainder of aqueous solution was added at one time into the stock solution, the pectin was poorly soluble in the solution, the foam was very dense rapidly turns back into the liquid state.

It is also worth noting that when the aqueous solution of pectin and surfactant is added in one time in the aqueous ethanolic solution, the resulting mixture is poorly soluble. It is important to add progressively the aqueous ethanolic solution into the aqueous ethanolic solution to obtain a homogenous solution.

In the method according to the present invention, at least 10% by volume of the ethanolic aqueous solution is added progressively to the stock solution. A progressive adding allows a better homogenization of the working solution and result in an improvement of the features of the foam, such as lightness or freshness. The progressive addition of ethanolic aqueous solution also improves the solubility of pectin in the working solution.

In an embodiment, the ethanolic solution and the aqueous solutions added to the stock solution are at room temperature, for instance at 25° C.

In one embodiment, step iii) further comprises adding progressively at least 10% of the remainder of the aqueous solution into the stock solution.

In an embodiment, step iii) further comprises adding a plurality of portions of aqueous ethanolic solution and a plurality of portions of the remainder of aqueous solution into the stock solution, the working solution being homogenous before the addition of each portion.

According to an embodiment, it is also possible to alternate between adding progressively some ethanolic aqueous solution and progressively some aqueous solution into the stock solution.

In an embodiment, the working solution comprises 10% of the ethanolic aqueous solution. It is possible to stock the working solution and to complete the working solution with the remainder of ethanolic aqueous solution and aqueous solution on demand, for instance upon receiving an order from a client. Thus, the method according to the invention facilitates the industrial process to prepare the foam.

In an embodiment, firstly 20% of ethanolic aqueous solution is progressively added into the stock solution, secondly, the remainders of ethanolic aqueous solution and aqueous solution are added progressively.

In an embodiment of the method according to the present invention:

step i) further comprises adding at least 50% by weight of the total amount of carbohydrate into the initial solution; and
step ii) further comprises adding the remainder of carbohydrate.

In one embodiment, step ii) further comprises adding the salts.

In an embodiment, the working solution is placed and sealed in a recipient. The recipient is subsequently pressurized with a propellant gas, typically carbon dioxide CO₂ or nitrous oxide N₂O, or mixture thereof, that will combined with the working solution to provide the foam. The recipient is classically equipped with a device for dispensing the foam in a controlled manner.

The alcoholic foam according to the present invention can be used for topping food or beverage. The alcoholic foam according to the present invention is edible and can be drunk or ingested alone or in combination with another food or beverage. The alcoholic foam can be dispensed on a soft drink or combined with another alcoholic beverage of any form to prepare a cocktail.

In one embodiment, the alcoholic foam further comprises a flavor agent, such as vanilla, coffee, and fruits flavors or any other flavor suitable to perfume a foam.

The embodiments regarding the foam according to the present invention apply mutatis mutandis to the method for preparing the foam according to the present invention and to the use of the foam and vice versa.

A method, a use or a foam according to the present invention can comprise an isolated embodiment.

A method, a use or a foam according to the present invention can comprise a combination of a plurality of embodiments.

In the context of the present invention, “alcoholic solution” and “ethanolic solution” are interchangeable.

In the context of the present invention, “alcohol solution” and “ethanol” solution” are interchangeable. In the context of the invention, “alcohol” refers to food and beverage alcohol, in particular ethanol.

Detailed Description of possible embodiments of the Invention

The invention will be better understood with the aid of the description of three embodiments given by way of example.

### EXAMPLE 1

An alcoholic foam based on vodka was prepared based on the following :
82.5% by volume of vodka (40% by volume)
17.5% by volume of water
1.2 g.L⁻¹ of a mixture of E 471/E472 as surfactants
1.0 g.L⁻¹ of pectin E440

### 0.2 g.L⁻¹ of NaCl

0.6 g.L⁻¹ of beetroot sucrose.
Example 1 describes the preparation of a vodka foam at 33% by volume alcohol.
The first step aims at preparing 1 liter of working solution. The surfactants and 0.3 g of sucrose are diluted in 115.5 mL of boiling water to prepare the initial solution. The initial solution is stirred at 85° C. until said solution is homogenous. Then, the pectin, the salt and the remainders of sucrose are added into the initial solution to prepare the stock solution. The stock solution is stirred at 85° C. until said solution is homogenous. Then, the temperature of the stock solution is decreased to 70 ° C. and 165 ml of vodka is added progressively. The addition of vodka is completed over several minutes so that the working solution remained homogenous during addition of vodka. Then, the remainders of vodka (660 mL) and of water (59.5 mL) are mixed, and the resulting mixture is added by portion of 70 mL into the working solution maintained at 70° C.

Then, the working solution is placed in a recipient, sealed and pressurized with carbon dioxide CO₂.

### EXAMPLE 2

An alcoholic foam based on vodka was prepared by following the process described in example 1, based on the following components:
82.5% by volume of vodka (40% by volume)
17.5% by volume of water
1.5 g.L⁻¹ of a mixture of E 471/E472 as surfactants
1.25 g.L⁻¹ of pectin E440

### 0.2 g.L⁻¹ of NaCl

0.6 g.L⁻¹ of beetroot sucrose.

### EXAMPLE 3

An alcoholic foam based on neutral spirit was prepared based on the following:
82.5% by volume of neutral spirit (40% by volume)
7.5% by volume of water
1.2 g.L¹ of a mixture of E 471/E472c as surfactants
1.0 g.L¹ of pectin E440

### 0.2 g.L⁻¹ of NaCl

0.6 g.L⁻¹ of beetroot sucrose.
Example 3 describes the preparation of a foam at 33% by volume alcohol. In this respect, the neutral spirit—96% ethanol by volume—was diluted to provide a neutral sprit at 40% ethanol by volume. Then, the foam based on the diluted spirit—40% by volume—was prepared by following the process of example 1 mutatis mutandis.

1. An alcoholic foam comprising:
An aqueous ethanolic solution;
An aqueous solution constituted essentially of water;
Between about 0.5 g.L.⁻¹ and about 10 g.L.⁻¹ of at least a surfactant;
Between about 0.5 g.L.⁻¹ and 10 g.L.⁻¹ of pectin.

2. The alcoholic foam according to claim 1, wherein said aqueous ethanolic solution comprises between 0.5% by volume of ethanol and 99.5% by volume of ethanol, preferably between about 10% by volume of ethanol and 60% by volume of ethanol, more preferably between about 35 by volume of ethanol and 55% by volume of ethanol.

3. The alcoholic foam according to claim 1, wherein the foam comprises between about 5% by volume and 95% by volume of aqueous ethanolic solution, preferably between about 50% by volume and 90% by volume of aqueous ethanolic solution, more preferably between about 80% by volume and 85% by volume of aqueous ethanolic solution.

4. The alcoholic foam according to claim 1, wherein the foam comprises between about 1.0 g.L.⁻¹ and about 5.0 g.L.⁻¹ of at least a surfactant, preferably between about 1.0 g.L.⁻¹ and about 1.5 g.L.⁻¹ of at least a surfactant.

5. The alcoholic foam according to claim 1, wherein the foam comprises between about 0.8 g.L.⁻¹ and about 5.0 g.L.⁻¹ of pectin, preferably between about 0.8 g.L.⁻¹ and about 1.3 g.L.⁻¹ of pectin.

6. The alcoholic foam according to claim 1 comprises between about 0.1 g.L.⁻¹ and about 1.0 g.L.⁻¹ of salts, preferably between about 0.1 g.L.⁻¹ and about 0.3 g.L.⁻¹ of salts.

7. The alcoholic foam according to claim 1, wherein the foam comprises between about 0.1 g.L.⁻¹ and 1.0 g.L.⁻¹ of carbohydrate, preferably between about 0.5 g.L.⁻¹ and about 0.7 g.L.⁻¹ of carbohydrate,

8. The alcoholic foam according to claim 1, wherein the surfactant is chosen amongst surfactant with a HLB inferior to 16, preferably inferior to 12, more preferably inferior to 9.

9. The alcoholic foam according to claim 1, wherein the surfactant are chosen amongst monoglycerides of fatty acids, diglycerides of fatty acids, citric acid esters of monoglycerides of fatty acids, citric acid esters of diglycerides of fatty acids or combination thereof.

10. (canceled)

11. The alcoholic foam according, to claim 1, wherein the salts comprises essentially sodium chloride.

12. The alcoholic foam according to claim 1, wherein the pectin comprises amidated pectin and/or non antidotal pectin.

13. The alcoholic foam according to claim 1, wherein the aqueous ethanolic solution comprises vodka, rum, gin, whisky, absinthe, tequila, neutral spirit or combination thereof.

14. (canceled)

15. The alcoholic foam according to claim 1, wherein the foam further comprises a propellant gas.

16. (canceled)

17. A method for preparing an alcoholic foam according to claim 1, the method comprising the steps of:
i. Preparing an initial solution by mixing the surfactant into at least 10% by volume of the total volume of the aqueous solution bring to the boil, the initial solution being mixed at a temperature between about 80° C. and 100° C. until said initial solution is homogenous;
ii. Preparing a stock solution by adding the pectin to the initial solution, the stock solution being mixed at a temperature between about 80° C. and 100° C. until said stock solution is homogenous;
iii. Preparing a working solution by progressively adding at least 10% by volume of the aqueous ethanolic solution into the stock solution, said stock solution being maintained at a temperature between about 65° C. and about 75° C.

18. The method according to claim 17 wherein step iii) further comprises adding progressively at least 10% of the remainder of the aqueous solution into the stock solution.

19. The method according to claim 17 wherein step iii) further comprises adding a plurality of portions of aqueous ethanolic solution and a plurality of portions of the remainder of aqueous solution into the stock solution, the working solution being homogenous before the addition of each portion,

20. The method according to claim 17, wherein:
step i) further comprises adding at least 50% by weight of the total amount of carbohydrate into the initial solution; and
step ii) further comprises adding the remainder of carbohydrate.

21. The method according to claim 17, wherein step ii) further comprises adding the salts.

22. The method according to claim 17, further comprising after step iii):
iv. Placing said working solution in a recipient;
v. Sealing the recipient and pressurized said recipient with a propellant gas.

23. Use of an alcoholic foam according to claim 1 for topping food or beverage.
